(19) United States
(12) Patent Application Publication
(10) Pub. No.: US 2016/0330642 A1
(43) Pub. Date: Nov. 10, 2016

(54) CIRCUIT SWITCHED FALLBACK

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/705,943

(22) Filed: May 6, 2015

(51) Int. Cl. H04W 24/10; H04W 16/18; H04B 17/318

(52) U.S. Cl. CPC H04W 24/10; H04B 17/318; H04W 16/18

(57) ABSTRACT

A user equipment (UE) adjusts a system information block (SIB) read abort timer to reduce mobile terminated circuit-switched fallback (CSFB) failure. In one instance, the UE receives a redirection list including frequencies to search for redirection and searches each frequency in the list to determine a strongest frequency. The UE then decodes short period system information blocks (SIBs) for a variable number of non-strongest frequencies until a strongest short period SIB is received. The UE adjusts a SIB read abort timer based on a signal quality of the strongest frequency and the variable number.

### BACKGROUND

1. Field

Aspects of the present disclosure relate generally to wireless communication systems, and more particularly, to redirection such as circuit switched fallback calls across wireless networks.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes receiving a redirection list including frequencies to search for redirection. The method also includes searching and measuring each frequency in the list to determine a strongest frequency. The method also includes decoding short period system information blocks (SIBs) for a variable number of non-strongest frequencies until a short period SIB of the strongest frequency is received. The method further includes adjusting a SIB read abort timer based on a signal quality of the strongest frequency and the variable number. It is noted that the term frequency is used to include channel and cell.

According to another aspect of the present disclosure, an apparatus for wireless communication includes means for receiving a redirection list including frequencies to search for redirection. The apparatus may also include means for searching and measuring each frequency in the list to determine a strongest frequency. The apparatus may also include means for decoding short period system information blocks (SIBs) for a variable number of non-strongest frequencies until a short period SIB of the strongest frequency is received. The apparatus further includes means for adjusting a SIB read abort timer based on a signal quality of the strongest frequency and the variable number.

Another aspect discloses an apparatus for wireless communication and includes a memory and at least one processor coupled to the memory. The processor(s) is configured to receive a redirection list including frequencies to search for redirection. The processor(s) is also configured to search and measure each frequency in the list to determine a strongest frequency. The processor(s) is also configured to decode short period system information blocks (SIBs) for a variable number of non-strongest frequencies until a short period SIB of the strongest frequency is received. The processor(s) is further configured to adjust a SIB read abort timer based on a signal quality of the strongest frequency and the variable number.

Yet another aspect discloses a computer program product for wireless communications in a wireless network having a non-transitory computer-readable medium. The computer-readable medium has non-transitory program code recorded thereon which, when executed by the processor(s), causes the processor(s) to receive a redirection list including frequencies to search for redirection. The program code also causes the processor(s) to search and measure each frequency in the list to determine a strongest frequency. The program code also causes the processor(s) to decode short period system information blocks (SIBs) for a variable number of non-strongest frequencies until a short period SIB of the strongest frequency is received. The program code further causes the processor(s) to adjust a SIB read abort timer based on a signal quality of the strongest frequency and the variable number.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a graph conceptually illustrating an example of system information collection during redirection according to one aspect of the present disclosure.

FIG. 6 is a block diagram illustrating a method for redirection according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

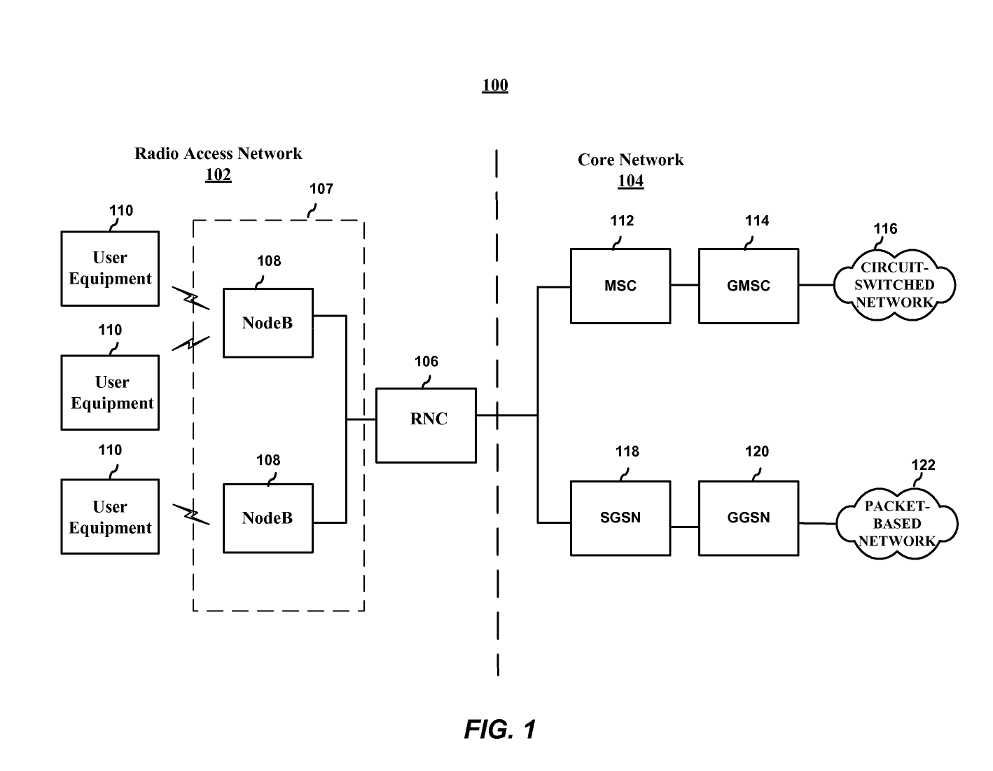

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

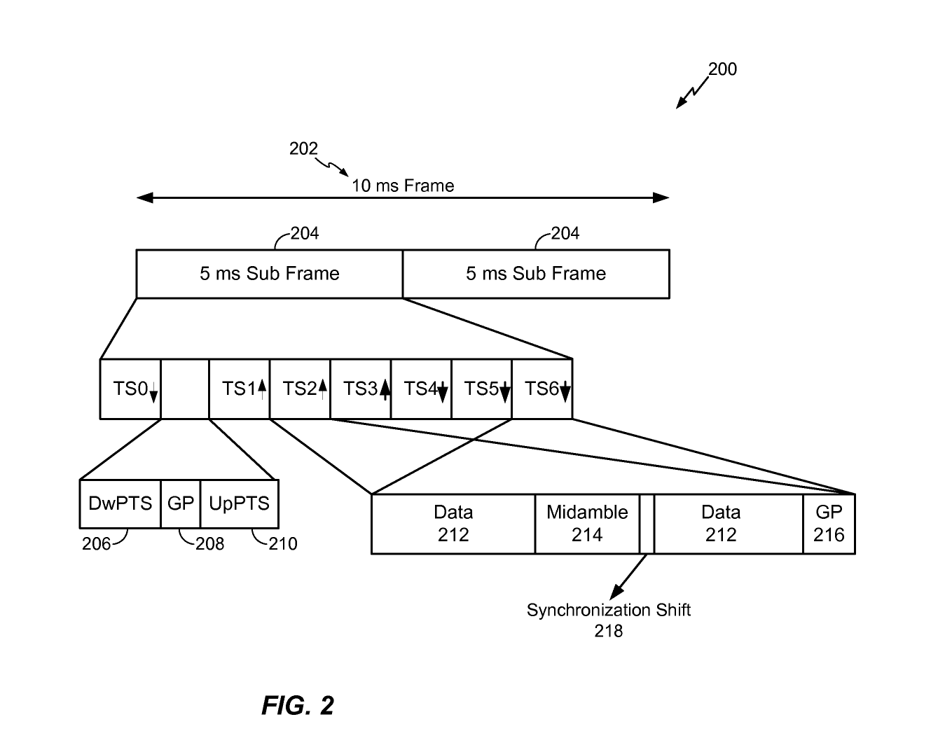

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

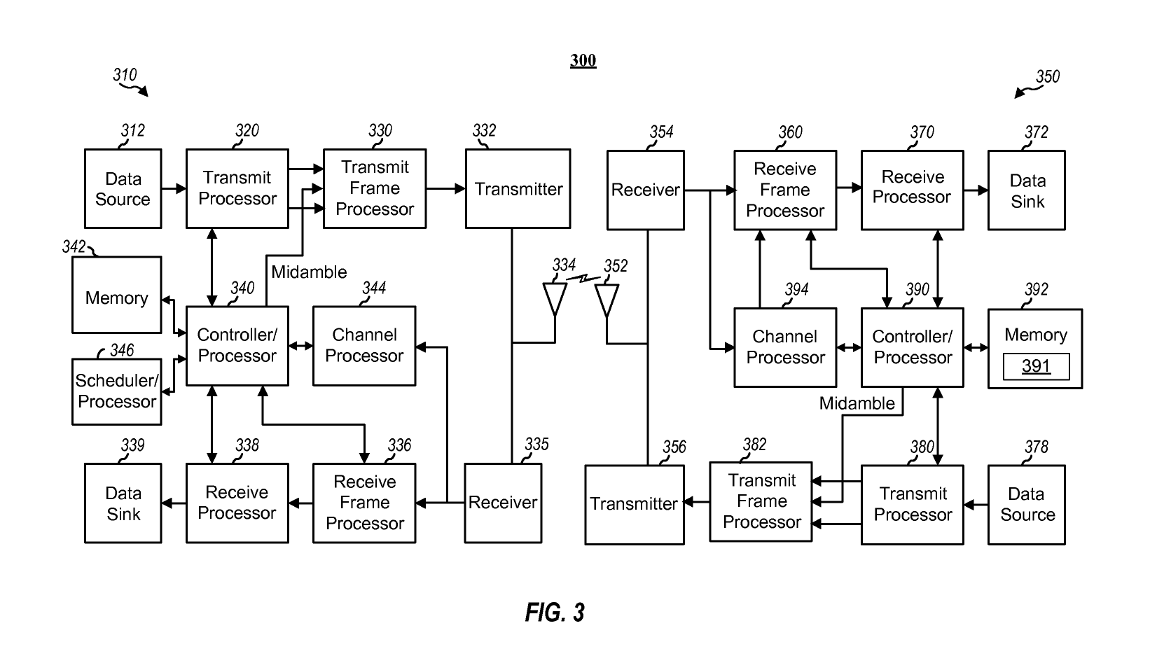

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames. Additionally, a scheduler/processor 346 at the node B 310 may be used to allocate resources to the UEs and schedule downlink and/or uplink transmissions for the UEs.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store an adjustable timer module 391 which, when executed by the controller/processor 390, configures the UE 350 for adjusting a timer such as a SIB read abort timer.

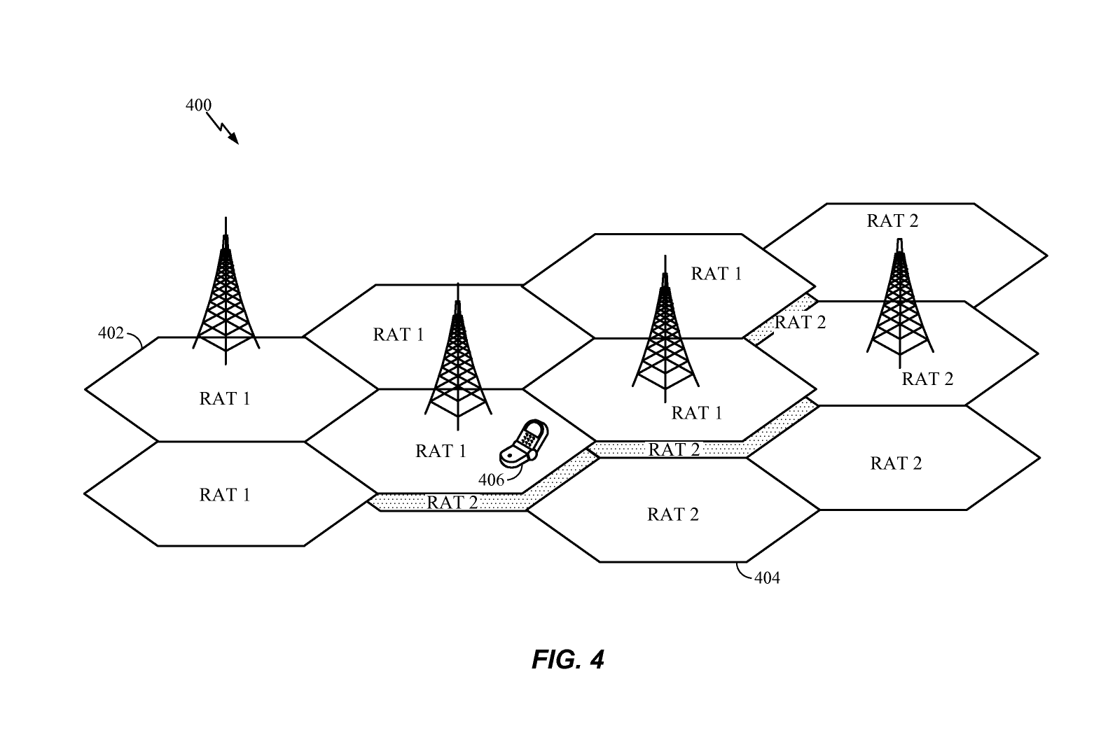

Some networks, such as a newly deployed network, may cover only a portion of a geographical area. Another network, such as an older more established network, may better cover the area, including remaining portions of the geographical area. FIG. 4 illustrates coverage of an established network utilizing multiple types of radio access technology (RAT) network, such as, for example, GSM (2G), TD-SCDMA (3G) and/or LTE (4G). The geographical area 400 may include RAT-1 cells 402 and RAT-2 cells 404. In one example, the RAT-1 cells are 2G or 3G cells and the RAT-2 cells are 4G (LTE) cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection, for example as part of a circuit switched fall back procedure.

The handover or cell reselection may be performed when the UE moves from a coverage area of a first RAT to the coverage area of a second RAT, or vice versa. A handover or cell reselection may also be performed when there is a coverage hole or lack of coverage in one network, as part of a circuit switched fall back procedure or when there is traffic balancing between a first RAT and the second RAT networks. As part of that handover or cell reselection process, while in a connected mode with a first system (e.g., 2G and/or 3G) a UE may be specified to perform a measurement of a neighboring cell (e.g., LTE). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

Redirection from one RAT to another RAT commonly occurs, for example, to implement load balancing. Redirection may also be utilized to implement circuit-switched fallback (CSFB) from one RAT, such as Long Term Evolution (LTE) to a second RAT, such as Universal Mobile Telecommunications System (UMTS) frequency division duplex (FDD), UMTS time division duplex (TDD), or GSM.

Circuit-switched fallback is a feature that enables multimode UEs that have, for example, third generation (3G)/second generation (2G) network capabilities in addition to LTE capabilities, to have circuit switched (CS) voice services while camped on an LTE network. A circuit-switched fallback capable UE may initiate a mobile-originated (MO) circuit-switched (CS) voice call while on LTE. This results in the UE being moved to a circuit-switched capable radio access network (RAN), such as a 3G or 2G network for circuit switched voice call setup. A circuit-switched fallback capable UE may be paged for a mobile-terminated (MT) voice call while on LTE, resulting in the UE being moved to a 3G or 2G network for circuit-switched voice call setup.

Various methods are utilized in an attempt to reduce latency that occurs during circuit-switched fallback call (CFSB) setup. For example, system information block (SIB) tunneling and deferred measurement control reading (DMCR) may be introduced to reduce latency for call setup. For CSFB to UTRAN, the delay related to call setup may increase due to additional signaling on both the LTE and circuit-switched RAT network. A substantial part of the call setup delay results from reading system information on the circuit-switched RAT prior to the access procedure. After completing the collection of system information, the UE begins the access procedure to set up the circuit-switched call in the circuit-switched RAT.

Call establishment latency is a factor used to evaluate CSFB performance. The UE cannot perform power scans on all of the frequencies deployed for operators because a full power scan may takes 20 or more seconds, which is not accepted under CSFB call latency performance specifications.

When a UE receives a radio resource control (RRC) release message (e.g., LTE release message) with a redirection command, the redirection command may include a list of frequencies. (It is noted that the terms frequency and channel are used interchangeably.) For example, the redirection command may include a list of 2G (e.g. GSM) absolute radio-frequency channel numbers (ARFCNs). The UE performs a power scan for all of the frequencies (e.g. GSM ARFCNs) in the list. The UE determines which are the strongest signals and ranks the frequencies in order of signal quality. The term “signal quality” is intended to include any type of signal metric, such as, but not limited to the quality of a signal, the strength of a signal, etc.

In some scenarios, the UE only ranks the frequencies having a signal quality above a threshold. The signal quality may be based on received signal strength indicators (RSSIs) of the frequencies. For example, when the received signal strength indicator of a GSM channel (e.g., GSM ARFCN) is above a threshold, the UE performs a frequency correction channel/shared channel (FCCH/SCH) decoding to obtain frame numbers. The decoding may be performed based on the ranking of the of the channels. In one example, the UE only decodes the FCCH/SCH of the strongest GSM channel.

Based on the frame numbers carried in the scheduling channel, the UE calculates an arrival time of a broadcast control channel (BCCH), which includes a system information block (SIB). They system information blocks are typically short period SIBs that are repeatedly transmitted at short time period.

If there is sufficient time before the arrival of the broadcast control channel of the strongest GSM channel, the UE also decodes the FCCH/SCH of other GSM channels in order of signal quality. For example, the UE decodes a second, third, and/or fourth strongest GSM channels, and then calculates a BCCH arrival time for each of these GSM channels.

After the UE collects the system information (e.g., short period SIBs) included in the BCCH of the strongest GSM channel, the UE moves into an early camp procedure and begins decoding a specific BCCH (e.g., system information blocks (SIBs)). If the UE cannot collect all the SIBs within a fixed SIB read abort time period (e.g., 4 seconds), the UE performs a power scan on other circuit-switched RATs, such as a 2G/3G RAT. If a mobile switching center for the 2G/3G RAT is different, it can result in a complete mobile terminated CSFB failure.

Aspects of the present disclosure are directed to an adjustable SIB read abort timer. The SIB read abort timer controls the amount of time allotted for collecting the SIBs for the strongest frequency. For example, in one aspect of the present disclosure, the user equipment UE) receives a redirection list including a listing of frequencies to search for a redirection procedure, such as a circuit-switched fallback (CSFB) procedure. The user equipment performs search and measurement procedures for each frequency in the list to determine a strongest frequency. After decoding the FCCH/SCH for the strongest frequency, the user equipment then decodes the system information blocks (e.g., short period SIBs) for each frequency until a strongest SIB is received in a first phase of SIB collection and decoding. After the strongest SIB is received, the UE then moves into phase 2 for SIB collection and decoding. The SIB read abort timer controls when the UE will stop waiting for the strongest long period SIB during phase 2. That is, the SIB read abort timer controls the amount of time for collecting the remaining system information (e.g., SIBs) for the strongest frequency in phase 2 after decoding the initial SIB in phase 1.

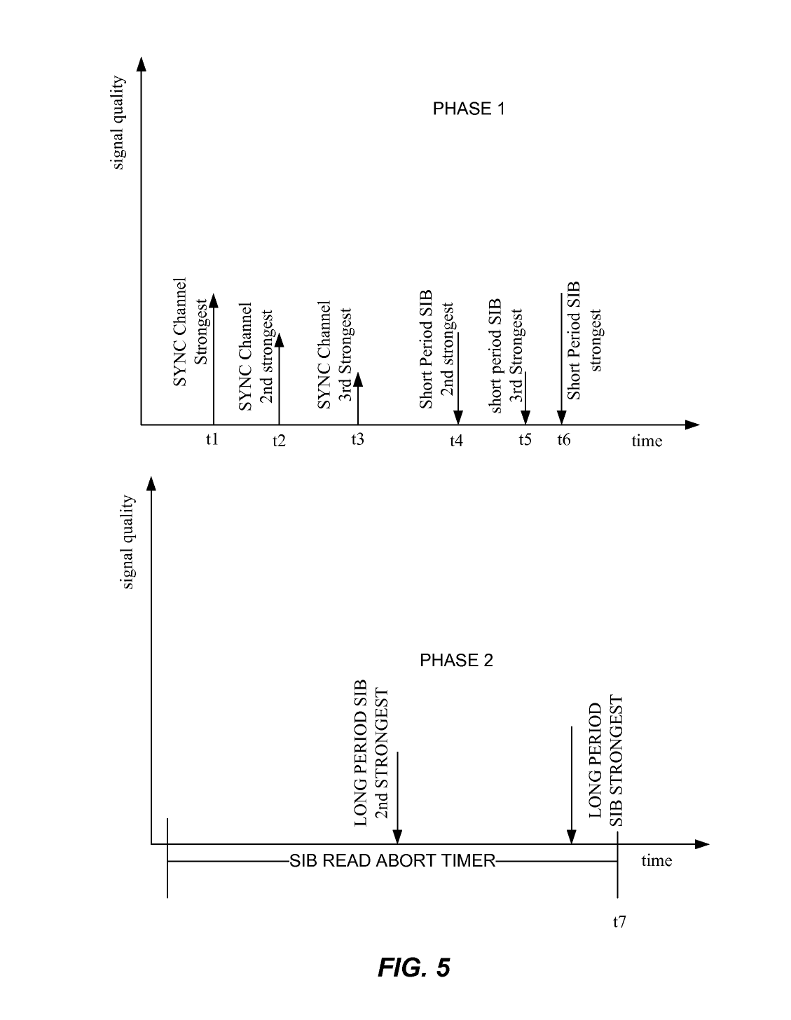

FIG. 5 is an graph conceptually illustrating two phases of system information collection during redirection according to aspects of the present disclosure. The x-axis illustrates time and the y-axis illustrates signal quality of each of the frequencies. For example, the x-axis illustrates times when the synchronization channel (FCCH/SCH) for each of the frequencies is decoded and time when the broadcast channel (or system information block carried in the broadcast channel) is decoded for each of the frequencies. In FIG. 5, the UE performs frequency correction channel/shared channel (FCCH/SCH) decoding (e.g. at times t1, t2, t3) to enable calculation of when the system information will arrive (e.g., at times t4, t5, t6).

Typically, the system information is transmitted repeatedly in short time blocks, or alternately, may be repeatedly transmitted in longer blocks of time. The UE collects the system information (e.g., SIBs) in two phases, depending on the transmission type. In particular, the SIBs repeatedly transmitted in short time periods (short period SIBs) are collected in the first phase. Additionally, during the first phase, the UE collects system information for multiple frequencies/channels/cells. In the second phase, the UE only collects system information for one frequency/channel/cell and collects the multiple SIBs repeatedly transmitted in longer time blocks (e.g., long period SIBs). The long period SIBs may include, for example, specific channel configurations, random access channel parameters, and neighbor information.

In the example of FIG. 5, long period SIBs are collected during phase 2, for example in GSM. The adjustable SIB read abort timer is applied to the second phase to control how long the UE waits to collect system information. In the example of FIG. 5, the long period SIBs are successfully collected and decoded before the SIB read abort timer expires at time t7. If, however, all of the SIBs are not collected before the timer expires at time t7, the UE aborts collecting SIBs for the strongest frequency/channel/cell. The UE then may proceed to phase 2 collecting of SIBs for another frequency/channel/cell, as discussed in more detail below.

According to the present disclosure, the SIB abort time is not fixed. Rather, the user equipment adjusts the SIB read abort timer based on factors such as, but not limited to: a received signal strength indicator (RSSI) of the strongest frequency/channel/cell; the signal strength differences between the strongest GSM channel and the non-strongest channels; and whether the SIBs for the non-strongest GSM channels/cells are already collected and the number of SIBs collected for the non-strongest GSM channel/cell.

In one example, the SIB read abort timer is adjusted when the signal strength of the strongest channel is poor (e.g., the signal strength is below a threshold). In particular, when the signal strength is below a threshold, the SIB read abort timer is shortened.

Additionally, the SIB read abort timer may be adjusted based on a signal quality difference between the strongest channel and the next strongest channel. If the difference in signal quality between the strongest channel and the next strongest channel is small, the SIB read abort timer may be shortened.

Further, the SIB read abort timer may be adjusted when SIBs have been collected for a non-strongest channel. For example, in FIG. 5, short period SIBs have been collected for the second and third strongest frequencies. When the short period SIBs for the non-strongest GSM channel are already collected, the long period SIB can be aborted earlier because short period SIBs are already collected. However, if no short period SIBs are collected, the timer may be extended. That is, the UE can abort the strongest cell earlier, because a backup is available.

In another aspect, when the UE fails to collect all SIBs within an adjusted SIB read abort timer, the UE refrains from initiating a search and power scan on other circuit switched (CS) RATs. Instead, in one aspect, the UE selects a next strongest frequency/channel/cell and begins decoding the SIBs for the selected next strongest frequency.

The UE may be configured with single receivers or with multiple receivers. In one aspect, a UE collects SIBs with multiple receivers in parallel. Alternately, the UE may collect SIBs with a single receiver in series. In one example, the SIBs are not transmitted continuously. Thus, the UE collects a first SIB until a first portion completes. The UE then movies to the next frequency for the next SIB as it arrives. The UE then returns to the first frequency after a portion of the next (second) SIB completes. When the UE is configured to collect SIBs with only a single receiver, the collection is based on system information arrival timing for each frequency. In particular, if the SIB corresponding to a third frequency (F3) arrives 1st, then that SIB is collected first. If, instead, a SIB corresponding to a second frequency (F2) arrives earlier, then that SIB is collected first. In some aspects, the sequence may dynamically change.

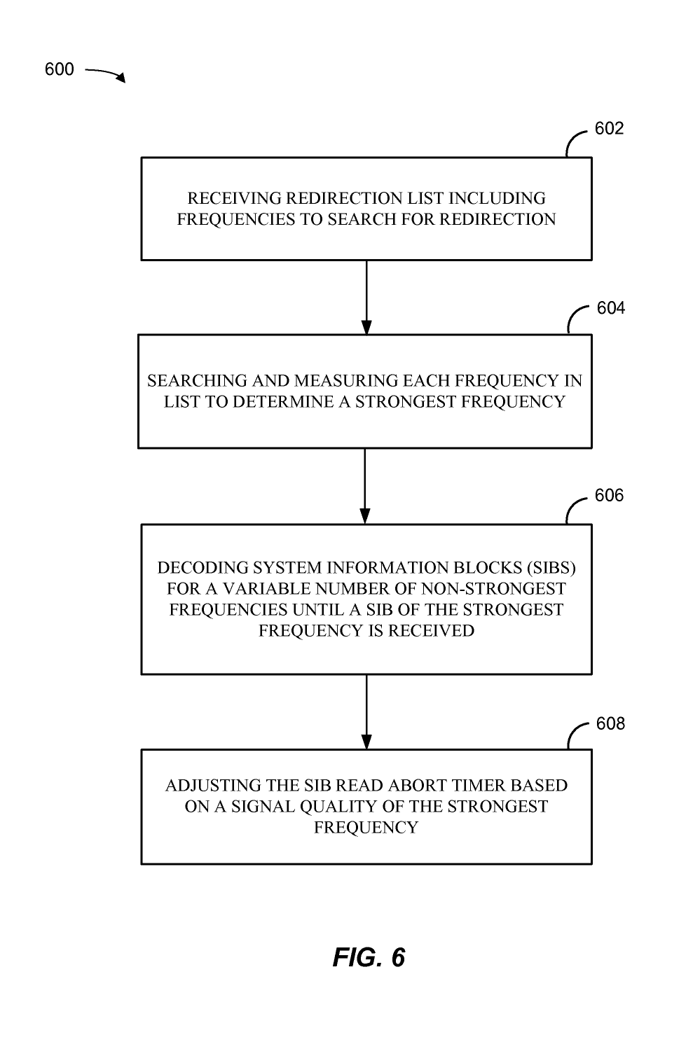

FIG. 6 shows a wireless communication method 600 according to one aspect of the disclosure. In block 602, a user equipment (UE) receives a redirection list having frequencies to search for redirection (e.g., circuit-switched fallback (CSFB)). The UE searches and measures each frequency in the list to determine the strongest frequency, as shown in block 604. Next, as shown in block 606, the UE decodes system information blocks (SIBs) for a variable number of non-strongest frequencies until a short period SIB of the strongest frequency is received. The number is variable because the arrival times of the SIBs are random within a range. The UE may collect 0, 1, 2, 3, etc. SIBs during phase 1. The UE adjusts the SIB read abort timer based on a signal quality of the strongest frequency, as shown in block 608. It is noted that the term frequency is used to include channel and cell.

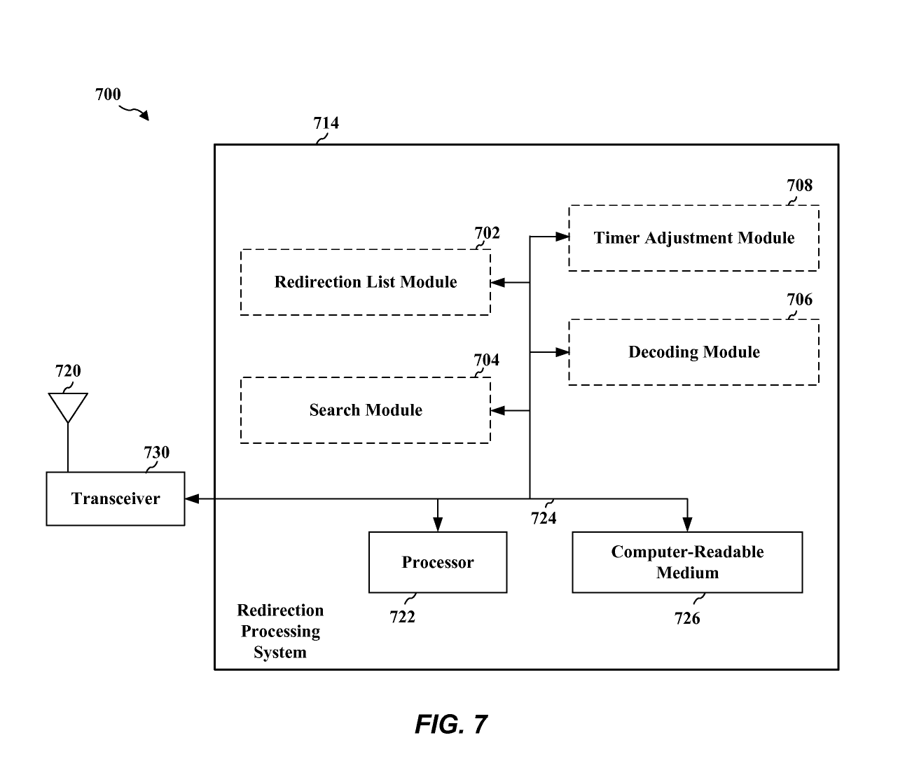

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706, 708 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a redirection list module 702 for receiving a redirection list. The processing system 714 includes a search module 704 for searching each frequency in a redirection list. The processing system 714 includes a decoding module 706 for decoding system information, including system information blocks. The processing system 714 also includes a timer adjustment module 708 for adjusting a SIB read abort timer. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for receiving. In one aspect, the receiving means may be the antennas 352, the receiver 354, the channel processor 394, the receive frame processor 360, the receive processor 370, the controller/processor 390, the memory 392, adjustable timer module 391, redirection list module 702, and/or the processing system 714 configured to perform the receiving means. The UE is also configured to include means for searching. In one aspect, the searching means may be the antennas 352, the receiver 354, the channel processor 394, the receive frame processor 360, the receive processor 370, the transmitter 356, the transmit frame processor 382, the transmit processor 380, the controller/processor 390, the memory 392, adjustable timer module 391, search module 704 and/or the processing system 714 configured to perform the searching means.

The UE is also configured to include means for decoding system information. In one aspect, the decoding means may be the antennas 352, the receiver 354, the channel processor 394, the receive frame processor 360, the receive processor 370, the transmitter 356, the transmit frame processor 382, the transmit processor 380, the controller/processor 390, the memory 392, adjustable timer module 391, decoding module 706, and/or the processing system 714 configured to perform the decoding means. The UE is also configured to include means for adjusting the SIB read abort timer. In one aspect, the adjusting means may be the controller/processor 390, the memory 392, adjustable timer module 391, timer adjustment module 708, and/or the processing system 714 configured to perform the adjusting means.

In one configuration, the means functions correspond to the aforementioned structures. In another aspect, the aforementioned means may be a module or any apparatus configured to perform the functions recited by the aforementioned means.

Several aspects of a telecommunications system has been presented with reference to GSM, TD-SCDMA and LTE systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a redirection list including frequencies to search for redirection;
searching and measuring each frequency in the list to determine a strongest frequency;
decoding short period system information blocks (SIBs) for a variable number of non-strongest frequencies until a short period SIB of the strongest frequency is received; and
adjusting a SIB read abort timer based at least in part on a signal quality of the strongest frequency and the variable number of non-strongest frequencies.

2. The method of claim 1, further comprising adjusting the SIB read abort timer based at least in part on a signal quality difference between the strongest frequency and a next strongest frequency.

3. The method of claim 1, further comprising adjusting the SIB read abort timer based at least in part on whether a SIB is collected for a non-strongest frequency and a number of SIBs collected for the non-strongest frequency.

4. The method of claim 1, further comprises refraining from initiating a search and measurement on other circuit switched (CS) RATs when a user equipment fails to collect all SIBs within an adjusted SIB read abort timer.

5. The method of claim 1, further comprising selecting a next strongest frequency and starting decoding SIBs for the selected next strongest frequency when a user equipment fails to collect all SIBs within an adjusted SIB read abort timer.

6. The method of claim 1, further comprising collecting SIBs with multiple receivers in parallel.

7. The method of claim 1, further comprising collecting SIBs with a single receiver in series.

8. The method of claim 7, in which SIBs are collected based on system information arrival timing for each frequency.

9. An apparatus for wireless communication, comprising:
means for receiving a redirection list including frequencies to search for redirection;
means for searching and measuring each frequency in the list to determine a strongest frequency;
means for decoding short period system information blocks (SIBs) for a variable number of non-strongest frequencies until a short period SIB of the strongest frequency is received; and
means for adjusting a SIB read abort timer based at least in part on a signal quality of the strongest frequency and the variable number of non-strongest frequencies.

10. The apparatus of claim 9, further comprising means for adjusting the SIB read abort timer based at least in part on a signal quality difference between the strongest frequency and a next strongest frequency.

11. The apparatus of claim 9, further comprising means for adjusting the SIB read abort timer based at least in part on whether a SIB is collected for a non-strongest frequency and a number of SIBs collected for the non-strongest frequency.

12. The apparatus of claim 9, further comprises means for refraining from initiating a search and measurement on other circuit switched (CS) RATs when a user equipment fails to collect all SIBs within an adjusted SIB read abort timer.

13. The apparatus of claim 9, further comprising means for selecting a next strongest frequency and means for starting decoding SIBs for the selected next strongest frequency when a user equipment fails to collect all SIBs within an adjusted SIB read abort timer.

14. The apparatus of claim 9, further comprising means for collecting SIBs with multiple receivers in parallel.

15. The apparatus of claim 9, further comprising means for collecting SIBs with a single receiver in series.

16. An apparatus for wireless communication, comprising:
a memory; and
at least one processor coupled to the memory and configured:
to receive a redirection list including frequencies to search for redirection;
to search and measure each frequency in the list to determine a strongest frequency;
to decode short period system information blocks (SIBs) for a variable number of non-strongest frequencies until a short period SIB of the strongest frequency is received; and
to adjust a SIB read abort timer based at least in part on a signal quality of the strongest frequency and the variable number of non-strongest frequencies.

17. The apparatus of claim 16, in which the processor is further configured to adjust the SIB read abort timer based at least in part on a signal quality difference between the strongest frequency and a next strongest frequency.

18. The apparatus of claim 16, in which the processor is further configured to adjust the SIB read abort timer based at least in part on whether a SIB is collected for a non-strongest frequency and a number of SIBs collected for the non-strongest frequency.

19. The apparatus of claim 16, in which the processor is further configured to refrain from initiating a search and measurement on other circuit switched (CS) RATs when a user equipment fails to collect all SIBs within an adjusted SIB read abort timer.

20. The apparatus of claim 16, in which the processor is further configured to select a next strongest frequency and to start decoding SIBs for the selected next strongest frequency when a user equipment fails to collect all SIBs within an adjusted SIB read abort timer.

21. The apparatus of claim 16, in which the processor is further configured to collect SIBs with multiple receivers in parallel.

22. The apparatus of claim 16, in which the processor is further configured to collect SIBs with a single receiver in series.

23. The apparatus of claim 22, in which SIBs are collected based on system information arrival timing for each frequency.

24. A non-transitory computer-readable medium having program code recorded thereon, the program code comprising:
program code to receive a redirection list including frequencies to search for redirection;
program code to search and measure each frequency in the list to determine a strongest frequency;
program code to decode short period system information blocks (SIBs) for a variable number of non-strongest frequencies until a short period SIB of the strongest frequency is received; and
program code to adjust a SIB read abort timer based at least in part on a signal quality of the strongest frequency and the variable number of non-strongest frequencies.

25. The non-transitory computer-readable medium of claim 24, further comprising program code to adjust the SIB read abort timer based at least in part on a signal quality difference between the strongest frequency and a next strongest frequency.

26. The non-transitory computer-readable medium of claim 24, further comprising program code to adjust the SIB read abort timer based at least in part on whether a SIB is collected for a non-strongest frequency and a number of SIBs collected for the non-strongest frequency.

27. The non-transitory computer-readable medium of claim 24, further comprising program code to refrain from initiating a search and measurement on other circuit switched (CS) RATs when a user equipment fails to collect all SIBs within an adjusted SIB read abort timer.

28. The non-transitory computer-readable medium of claim 24, further comprising program code to select a next strongest frequency and starting decoding SIBs for the selected next strongest frequency when a user equipment fails to collect all SIBs within an adjusted SIB read abort timer.

29. The non-transitory computer-readable medium of claim 24, further comprising program code to collect SIBs with multiple receivers in parallel.

30. The non-transitory computer-readable medium of claim 24, further comprising program code to collect SIBs with a single receiver in series.
